(19) United States
(12) Patent Application Publication
(10) Pub. No.: US 2016/0364784 A9
(43) Pub. Date: Dec. 15, 2016

(54) Online Registry Splash Page

(71) Applicant: Target Brands, Inc., Minneapolis, MN (US)

(72) Inventors: Sarah LAWRENCE, Minneapolis, MN (US); Sarah PETERSON, Minneapolis, MN (US); Gregory M. NATIONS, Minneapolis, MN (US); Chad R. GOURLEY, Elk River, MN (US); Patricia KORTH-MCDONNELL, Brooklyn, NY (US); Joe STEWART, Brooklyn, NY (US)

(73) Assignee: Target Brands, Inc., Minneapolis, MN (US)

(21) Appl. No.: 14/097,194

(22) Filed: Dec. 4, 2013

Related U.S. Application Data
(62) Division of application No. 12/973,875, filed on Dec. 20, 2010, now Pat. No. 8,630,913.

(51) Int. Cl. G06Q 30/06

(52) U.S. Cl. CPC G06Q 30/0633; G06Q 30/0641

(57) ABSTRACT

In one embodiment, a web page presented to a user includes a header section that substantially spans the top of the web page and provides a menu of selectable options as well as a search input box. A main section beneath the header section provides a registry creation control, selectable to activate a gift registry creation process, and a registry search box, providing a user with a means for searching for a particular gift registry. Beneath the main section, two promotional regions are positioned side-by-side. One of the promotional regions includes two or more sub-regions, each sub-region presenting information regarding a respective promotional concept. The other promotional region presents information regarding a main promotional concept. In some embodiments, the sub-regions are vertically aligned in a column.

A user interacts with a web browser in order to view web pages on the Internet while searching for information. A collection of related web pages, for example, created by a single person, company, or entity is referred to as a web site.

Some web sites allow a user to create a user account. To create an account the user is asked to create a username and password and complete an account profile. A completed account profile includes information such as the user's name, home address, and username for social networking sites. When signed on through a combination of username and password, for example, the user accesses information including their past purchases, shopping lists, and the shipping status of their past purchases.

Some web pages are customized based on the user's account profile. Customized web pages display user specific information including a user specific welcome message, local store information, product reviews from members of the user's social network, and suggested products based on the user's past purchases.

A user creates a gift registry to share purchase interests with others. For example, a user creates a wedding gift registry to allow wedding guests to shop for desired items. Other common registries include baby shower registries, birthday gift registries, and bar or bat mitzvah registries.

### SUMMARY

In one embodiment, a web page presented to a user includes a header section that substantially spans the top of the web page and provides a menu of selectable options as well as a search input box. A main section beneath the header section provides a registry creation control, selectable to activate a gift registry creation process, and a registry search box, providing a user with a means for searching for a particular gift registry. Beneath the main section, two promotional regions are positioned side-by-side. One of the promotional regions includes two or more sub-regions, each sub-region presenting information regarding a respective promotional concept. The other promotional region presents information regarding a main promotional concept. In some embodiments, the sub-regions are vertically aligned in a column.

In another embodiment, a web page presented to a user includes a shopping cart indicator and a product description including a product image and a product price. Selection of a purchase control associated with the product description causes the addition of the associated product to the shopping cart feature. Selection of the purchase control or the shopping cart indicator causes the generation of a pop-up window including a checkout region and a shopping cart summary region. A checkout control is displayed in the checkout region. Product descriptions related to each product selected for purchase are arranged in the shopping cart summary region.

In a further embodiment, a web page presented to a user includes a header section that substantially spans the top of the web page and provides a menu of selectable options as well as a search input box. A main section beneath the header section provides share registry control. Beneath the main section, a third region displays information regarding a gift registry. The third region includes one or more product category regions, each product category region including one or more product sub-categories. Each product sub-category includes a respective circle icon, the circle icons optionally including a first numeral indicating a number of items within the respective product sub-category. Each product sub-category is selectable to cause the presentation of one or more items categorized within the respective product sub-category which are available to purchase through a retailer associated with the web page. The share registry control is selectable to cause the presentation of a user interface configured to accept information related to one or more additional users and to cause the sharing of gift registry information with the one or more additional users.

The details of one or more embodiments are set forth in the accompanying drawings and the description below. Other features and advantages will be apparent from the description and drawings, and from the claims.

### DESCRIPTION OF DRAWINGS

This document describes these and other aspects in detail with reference to the following drawings.

FIGS. 1A and 1B show two views of an example retail web page.

FIG. 2 shows another view of an example retail web page.

FIG. 3 shows a further view of an example retail web page.

### DETAILED DESCRIPTION OF ILLUSTRATIVE EMBODIMENTS

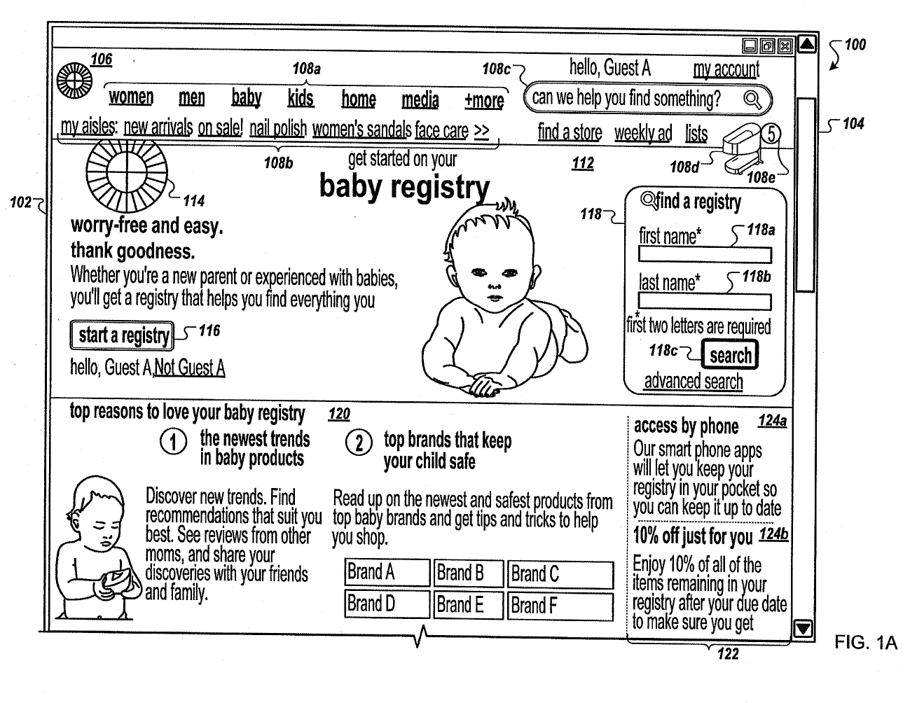

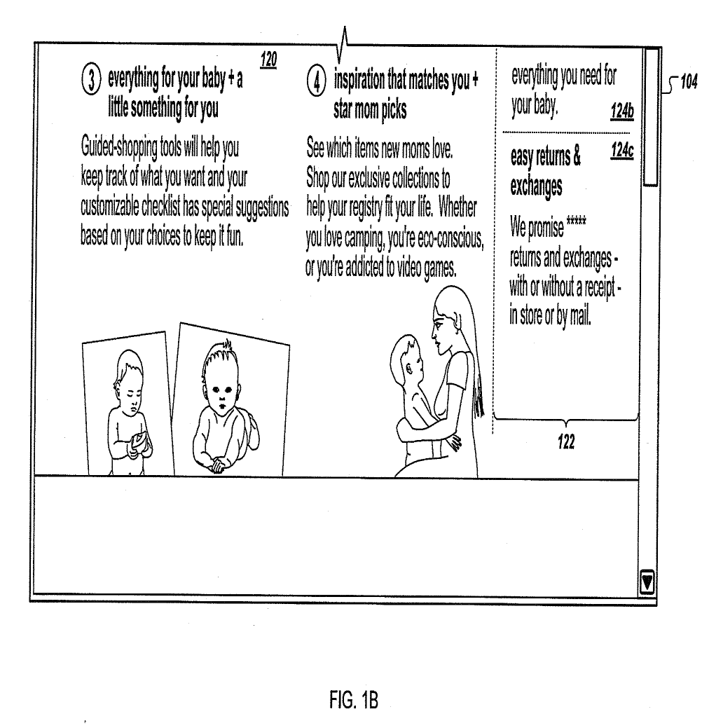

Referring to FIG. 1A, an example web page 100 is displayed in a window 102 of a screen (e.g., a computer monitor, a smart phone display, a television). In general, the web page 100 is laid out to be substantially the width of the window 102 and extends vertically. In some implementations, the web page 100 includes more information than is conveniently displayed on the window 102 at one time. For example, a user interacts with a scroll bar 104 to shift the view of the web page 100 vertically. As seen in FIGS. 1A-1B, the scroll bar 104 is illustrated in two different positions, corresponding to two different vertically located views of the web page 100.

The web page 100 includes a page header 106 substantially spanning the width of the web page 100. The page header 106 includes a collection of menu items 108a and a collection of menu items 108b. In some implementations, the user selects the menu items 108a-108b to link to other web pages or to activate the display of submenu items.

A search input box 108c is provided for users to enter search strings. For example, the user could type in keywords associated with a product he or she is seeking (e.g., “blue jeans”, “frozen pizza”, “batteries”) to activate a search routine that helps the user find what he or she is shopping for.

A shopping cart indicator 108d is selected by the user to display a list of items the user has already selected to purchase. A quantity indicator 108e is superimposed on the shopping cart indicator 108d. The quantity indicator 108e displays the quantity of items that the user has already selected for purchase (e.g., how many items are in the user's virtual shopping cart or bag). In some implementations, the quantity indicator 108e is displayed only when the user has selected one or more items for purchase (e.g., displayed only when the virtual shopping bag has something in it).

Below the page header 106 is a registry region 112. The registry region 112 provides information about one or more gift registry services available through the retailer. The registry region 112 includes a retailer logo 114, a “start a registry” control 116, and a “find a registry” search box 118. The “start a registry” control 116, when activated, causes the presentation of an interactive online service, such as a separate web page, including controls providing options for a user to generate a new gift registry. The “find a registry” search box 118 includes a first name field 118a, a last name field 118b, and a search control 118c. A user, for example, populates at least one of the first name field and the last name field, then activates the search control 118c to issue a query to a registry database, locating a registry created by an individual described by the information submitted in the name fields 118a and 118b.

Beneath the registry region 112, a main promotional region 120 is aligned to the left of a column region 122 of promotional sub-regions 124a, 124b, and 124c (as shown in FIG. 1B). The main promotional region 120, in some implementations, is substantially greater in width than the promotional sub-regions 124a, 124b, and 124c. The main promotional region 120, for example, contains information pertaining to the advantages of creating a gift registry with the retailer, while each of the promotional sub-regions 124a, 124b, and 124c list other information pertaining to gift registries. For example, a first promotional sub-region 124a provides information regarding accessing a gift registry using a mobile device such as a smart phone. A second promotional sub-region 124b offers a discount available after an event (e.g., baby due date, wedding, birthday, etc.) has passed. As shown in FIG. 1B, a third promotional sub-region 124c describes the merchandise return and exchange policy for the retailer. In other implementations, the promotional sub-regions 124a, 124b, and 124c include featured products, sponsored products, or other promotional information regarding the retailer.

In various implementations, rich content is positioned “below the fold,” or below the bottom of the screen as the webpage is initially displayed to a user. FIG. 1B depicts content that is displayed below the fold, or below the bottom edge of the display of FIG. 1A. The content displayed below the fold, in some implementations, is selected so as to draw consumers' attention below the fold. For instance, the partial information displayed in the main promotional region 120 or the second promotional sub-region 124b in FIG. 1 may encourage a consumer to scroll down, below the fold, if the consumer is interested in reading the additional information. Such an approach, in certain embodiments, has the effect of rendering the middle and bottom portions of the page more usable or valuable including in the sense that those regions will more likely be viewed by consumers.

The “fold” on a page will often be a function of the aspect ratio of the monitor on which the web page is displayed. The depicted displays have an aspect ratio of about 1:1. Monitors typically have an aspect ratio of about 1:1 or less, sometimes about 3:2 for wide-screen monitors.

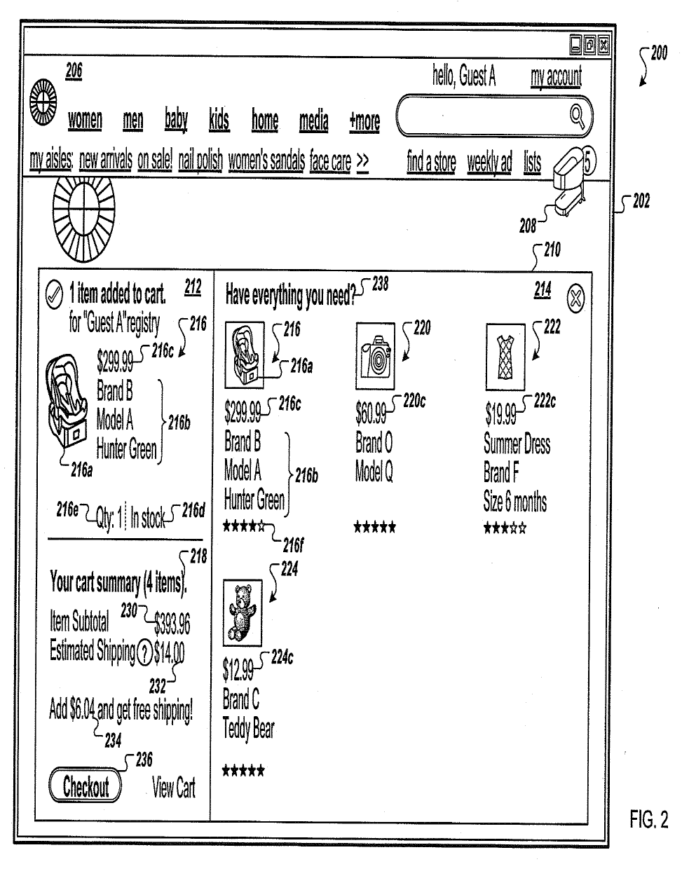

Referring now to FIG. 2, a web page 200 is displayed in a window 202. The web page 200 includes a page header 206 that is substantially similar to the page header 106 of FIG. 1A.

A shopping cart pop-up window 210 is superimposed upon the web page 200. In some examples, the shopping cart pop-up window 210 is generated when a user selects an item from a gift registry to purchase (e.g., through the selection of a purchase control), or when a user selects (or, optionally, hovers over) a shopping cart indicator 208. The shopping cart pop-up window 210 includes a checkout region 212 and a cart summary region 214.

The top of the checkout region 212 illustrates a most recently added product description 216 including a most recently added product image 216a, a most recently added product description 216b, a most recently added product price 216c, a most recently added product availability indicator 216d, and a selected quantity indicator 216e.

Beneath the product description, a cart summary indicator 218 indicates that a total of four items have been added to the shopping cart. Each of these four items, for example, is displayed within the cart summary region 214. For example, the most recently added product image 216a, a portion of the most recently added product description 216b, and the most recently added product price 216c, along with a most recently added product rating 216f are displayed in the cart summary region 214, along with product descriptions 220, 222, and 224.

Returning to the cart summary region 214, the totals of all of the product prices 216c, 220c, 222c, and 224c are listed as an item subtotal 230. To this total, an estimated shipping cost indicator 232 is optionally added. For example, a user avoids the shipping charges by adding one or more additional products to the shopping cart with a purchase price meeting or exceeding a free shipping purchase total variance as noted in a purchase total variance indicator 234. The cart summary region 214 includes a message 238 encouraging the user to consider purchasing additional items. If the user is ready to check out, the user selects a checkout control 236 which, when activated, causes the generation of a checkout routine. For example, a checkout routine includes a web page or series of web pages with interactive controls used to indicate payment and shipping information. In another example, the checkout routine accesses stored information (e.g., associated with a user profile registered with the retailer) to automatically process a purchase order.

In various implementations, the width ratio of the checkout region 212 to the cart summary region 214 of the pop-up window 210 is substantially less than 50:50. In the example of FIG. 2, the width ratio is about 40:60. In other embodiments, the width ratio is about 30:70 to about 45:55.

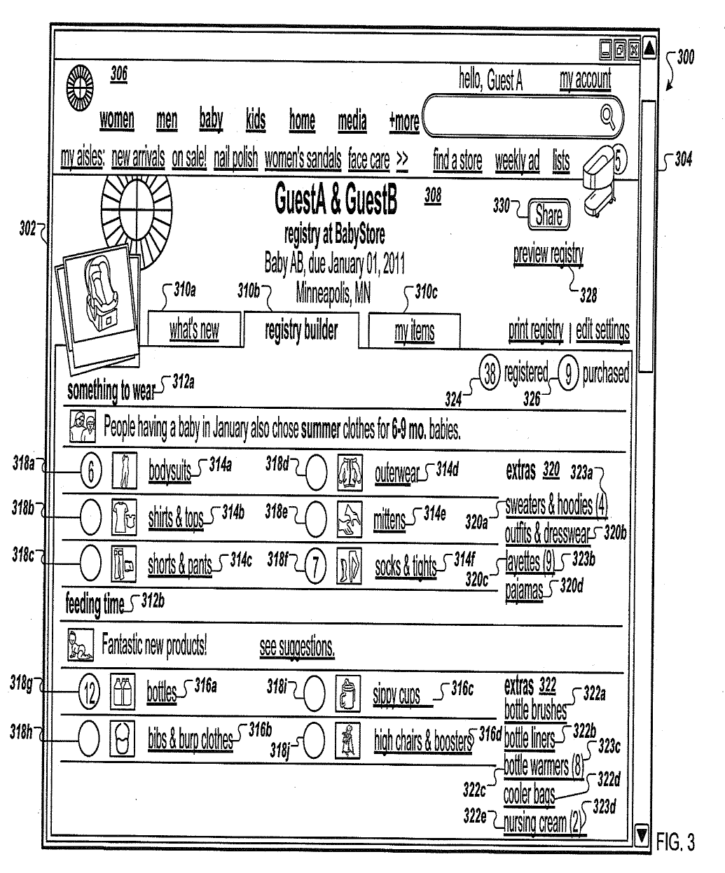

Referring to FIG. 3, an example web page 300 is displayed in a window 302 of a screen (e.g., a computer monitor, a smart phone display, a television). In general, the web page 300 is laid out to be substantially the width of the window 302 and extends vertically. In some implementations, the web page 300 includes more information than is conveniently displayed on the window 302 at one time. For example, a user interacts with a scroll bar 304 to shift the view of the web page 300 vertically.

The web page 300 includes a page header 306 that is substantially similar to the page header 106 of FIG. 1A. Beneath the page header 306, a guest registry region 308 includes information regarding a gift registry personalized by GuestA. For example, the user GuestA selects the “start a registry” control 116 as shown in FIG. 1A to create a personalized gift registry. Selection of the “start a registry” control 116, for example, causes the generation of the web page 300. Beneath the guest registry region, a series of registry building tabs 310 are available to the user including a “what's new” tab 310a, a “registry builder” tab 310b, and a “my items” tab 310c.

The registry builder tab 310b is currently active. The user selects the “registry builder” tab 310b, for example, to access recommendations for adding to a gift registry. For example, the baby gift registry building information displayed by web page 300 includes product categories 312 (e.g., “something to wear” 312a and “feeding time” 312b) as well as individual product sub-categories 314, 316 within each product category 312. The “registry builder” tab 310b, in some embodiments, includes any number of product categories 312 with any number of optional product sub-categories. The user, for example, uses the scroll bar 304 to access additional product categories 312 and, optionally product sub-categories listed in the “registry builder” tab 310b. The user selects a particular product sub-category 314 or 316, for example, to register for items within the selected product sub-category 314 or 316. For example, selection of a socks & tights product sub-category 314f causes the generation of a web page including one or more products, categorized as baby socks or baby tights, available for purchase through the web site.

In some implementations, one or more of the product sub-categories 314, 316 are broken down into further detail. In one example, the recommended product sub-category outerwear 314d is further broken down into jackets, snow suits, and buntings.

Each product sub-category 314, 316 is associated with a circle icon 318. The circle icon 318, in some embodiments, alerts the user to the number of items currently registered within each of the sub-categories 314, 316. For example, a sub-category bodysuits 314a is associated with a circle icon 318a including the numeral “6” indicating that the user has registered for six items within the sub-category bodysuits 314a. If no numeral is included in a particular circle icon 318, such as the circle icon 318b associated with the sub-category shirts & tops 314b, this, for example, indicates that the user has not yet registered for any items within the sub-category shirts & tops 314b. In some embodiments, the circle icon 318 serves as a suggestion to the user of a recommended number of items to register for in each of the sub-categories 314, 316. For example, the sub-category bottles 316a is associated with a circle icon 318g including the numeral “12”, suggesting to the user that registering for a dozen bottles would be appropriate for the typical baby gift registry. If the user registers for one or more bottles, in some implementations, the numeral in the circle icon 318g associated with the product sub-category bottles 316a is decremented to provide an updated recommendation for additional number of products to be registered in the product sub-category bottles 316a.

Associated with each of the product categories 312a and 312b, to the right of the respective product sub-categories 314 and 316, a first extras region 320 and a second extras region 322 list more product sub-categories. The extras regions 320 and 322, in some implementations, present product categories considered optional to the registry. For example, the product sub-categories 314 and 316 include items considered as essential baby products, while the extras regions 320 and 322 include items less frequently purchased for infants, such as bottle warmers 322c or cooler bags 322d. In some implementations, the extras regions 320 and 322 serve as suggestions to a user of product sub-categories not yet included in the gift registry presented by the web page 300. For example, after the user has registered for products in one or more product sub-categories, additional product sub-categories are presented to the user in the extras regions 320 and 322, such as layettes 320c and pajamas 320d, to encourage the user to consider additional registry items.

One or more of the product sub-categories listed in the extras regions 320 and 322, in some implementations, include an associated total number of items 323. In some examples, the total number of items 323 refers to a number of promotional items (e.g., on sale, clearance, or special offer) included in the particular product sub-category, a number of new items included in the particular product sub-category, or a number of user-recommended items included in the particular product sub-category (e.g., based upon previous purchase behavior, items currently registered for, previous browsing behavior, etc.). For example, sweaters & hoodies 323a is associated with a total number of items 323a of four, while layettes 323b is associated with a total number of items 323b of nine.

In addition to building a gift registry through the “registry builder” tab 310b, in some implementations, the user selects the “what's new” tab 310a to review new baby products available for purchase or the “my items” tab 310c to review baby products selected for purchase for the particular user. In some examples, products presented upon selection of the “my items” tab 310c include products recommended to the user based upon user history and other user data such as previous purchase behavior, items currently added to the gift registry, or previous browsing behavior. In other implementations, selection of the “my items” tab 310c presents the user with a list of products currently added to the gift registry.

In the top right corner of the registry builder tab 310b, a registered products indicator 324 presents a tally of the total number of items registered within the gift registry while a purchased indicator 326 presents a tally of the total number of items already purchased from the gift registry. The user, for example, reviews the registered products indicator 324 to determine whether he or she has included an adequate number of gifts in the registry. In another example, the user compares the tally presented by the purchased indicator 326 to the tally presented in the registered products indicator 324 to determine whether to register for more gifts (e.g., all or nearly all of the registered gifts have already been purchased).

When the user has completed registering for products, the user selects a preview registry control 328 within the guest registry region 308 to view the registry as presented to a guest shopping for a gift. For example, selection of the preview registry control 328 causes the presentation of an additional web page including a gift registry interface. In other implementations, selection of the preview registry control 328 presents the user with a printable document. The printable document, for example, is provided to a user for shopping for registered gifts in a bricks and mortar store associated with the web page 300.

The user selects a share control 330, presented above the preview registry control 328, to share the registry information with additional users. For example, selection of the share control 330 launches a new web page or a pop-up window providing the user with the ability to provide the registry information with one or more users. The user indicates the other users, in some examples, by providing the email addresses of the other users, selecting the other users from a “friends” list of other users registered with the web site, selecting the other users from a “friends” list provided by a third party social networking system, or providing the phone numbers of the other users to have registry information sent to the other users through text messaging.

The guest registry region 308 also includes a print registry control for printing a copy of the registry information and an edit settings control for modifying gift registry settings. The gift registry settings, in some examples, may include the name of the baby, the due date of the baby, a theme (e.g., colors, wallpaper, images) to apply to the gift registry, or a baby shower party date.

A number of implementations have been described. Nevertheless, it will be understood that various modifications may be made without departing from the spirit and scope. For example, advantageous results may be achieved if the steps of the disclosed techniques were performed in a different sequence, if components in the disclosed systems were combined in a different manner, or if the components were replaced or supplemented by other components. The functions and processes (including algorithms) may be performed in hardware, software, or a combination thereof, and some implementations may be performed on modules or hardware not identical to those described. Accordingly, other implementations are within the scope of the following claims.

1. (canceled)

2. (canceled)

3. (canceled)

4. (canceled)

5. A computer-implemented method of rendering one or more web pages, the computer-implemented method including the step of:
operating one or more computers to serve one or more files to render a first web page, the first web page including:
a shopping cart indicator;
a first product description, the first product description including a first product image and a first product price; and
a first purchase control associated with a first product described by the first product description, the first purchase control selectable to cause the addition of the first product to a shopping cart feature associated with the shopping cart indicator, wherein
selection of one of the shopping cart indicator and the first purchase control causes the generation of a pop-up window, the pop-up window including
a first region including a shopping cart summary and a checkout control selectable to cause the generation of a purchase order, and
a second region including one or more product summary descriptions, each product summary description describing a respective product selected by a user for purchase, wherein
the first region is horizontally aligned with the second region,
the first region and the second region are substantially identical in height.

6. The computer₌implemented method of claim 5, wherein the pop-up window is generated upon selection of the first purchase control.

7. The computer-implemented method of claim 6, wherein the second region further includes a first product summary description including the first product price and a first preview image substantially identical to the first product image.

8. The computer-implemented method of claim 7, wherein interaction with the shopping cart indicator will cause the generation of a first display over a portion of the first web page, the first display having two horizontally aligned regions, one of the horizontally aligned regions including the first product price and the first preview image, the other of the two horizontally aligned regions having a shopping cart summary and a checkout control selectable to cause the generation of a purchase order.

9. The computer-implemented method of claim 8, wherein the first display is generated by hovering over the shopping cart indicator.

10. The computer-implemented method of claim 5, wherein the shopping cart summary includes a total number of items and an item cost subtotal.

11. The computer-implemented method of claim 9, wherein the first display is the pop-up window.

12. The computer-implemented method of claim 5, wherein the pop-up window further includes a message indicating a condition for free shipping eligibility.

13. (canceled)

14. (canceled)

15. (canceled)

16. (canceled)

17. (canceled)

18. (canceled)

19. (canceled)

20. A system of rendering one or more web pages on a graphical user interface, the system comprising:
one or more computers to serve one or more files to display a first web page on a graphical user interface, the first web page including:
a shopping cart indicator;
a first product description, the first product description including a first product image and a first product price; and
a first purchase control associated with a first product described by the first product description, the first purchase control selectable to cause the addition of the first product to a shopping cart feature associated with the shopping cart indicator,
the shopping cart indicator being configured to generate a first display over a portion of the first web page when a user interacts with the shopping cart indicator, the first display including
a first region including a shopping cart summary and a checkout control selectable to cause the generation of a purchase order, and
a second region including one or more product summary descriptions, each product summary description providing information on a respective product selected by a user for purchase, wherein
the first region is horizontally aligned with the second region,
the first region and the second region are substantially identical in height; and
the first purchase control being configured to generate a second display over a portion of the first web page when a user interacts with the first purchase control, the second display including
a third region including a shopping cart summary and a checkout control selectable to cause the generation of a purchase order, and
a fourth region including one or more product summary descriptions, each product summary description providing information on a respective product selected by a user for purchase, wherein
the third region is horizontally aligned with the fourth region,
the third region and the fourth region are substantially identical in height.

21. The system as set forth in claim 20, wherein the first display is a first pop-up window.

22. The system as set forth in claim 21, wherein the second display is a second pop-up window.

23. The system as set forth in claim 22, wherein the first pop-up window and the second pop-up window are identical.

24. The system as set forth in claim 20, wherein the first display and the second display each include a first product summary description including the first product price and a first preview image substantially identical to the first product image.

25. The system as set forth in claim 24, wherein the first display is generated by hovering over the shopping cart indicator.

26. The system as set forth in claim 25, wherein the first display is a pop-up window appearing below a header of the first web page permitting a user to interact with the header when the pop-up window is displayed, the header including a plurality of menu items, each of the plurality of menu items are linked to one or more other web pages.

27. The system as set forth in claim 20, wherein the second display is a pop-up window appearing below a header of the first web page permitting a user to interact with the header when the pop-up window is displayed, the header includes a plurality of menu items, each of the plurality of menu items are linked to one or more other web pages.

28. A computer-implemented method of rendering one or more web pages, the computer-implemented method including the step of:
operating one or more computers to serve one or more files to render a first web page, the first web page including:
a shopping cart indicator;
a first product description, the first product description including a first product image and a first product price; and
a first purchase control associated with a first product described by the first product description, the first purchase control selectable to cause the addition of the first product to a shopping cart feature associated with the shopping cart indicator, wherein
interaction with one of the shopping cart indicator and the first purchase control causes the generation of a pop-up window, the pop-up window including
a first region including a shopping cart summary and a checkout control selectable to cause the generation of a purchase order, and
a second region including one or more product summary descriptions, each product summary description providing information on a respective product selected by a user for purchase, wherein
the first region is horizontally aligned with the second region,
the first region and the second region are substantially identical in height; and
interaction with the other of the shopping cart indicator and the first purchase control causes the generation of a first display over a portion of the first web page, the first display including a shopping cart summary, a checkout control selectable to cause the generation of a purchase order and pricing information for one or more products.

29. The computer-implemented method of claim 28, wherein the first display is identical to the pop-up window.

30. The computer-implemented method of claim 28, wherein the first display includes a third region having the shopping cart summary and the checkout control and a fourth region having the pricing information for one or more products.

31. The computer-implemented method of claim 30, wherein the third region is horizontally aligned with the fourth region and the third region and the fourth region are substantially identical in height.
